(19) United States
(12) Patent Application Publication
(10) Pub. No.: US 2009/0277074 A1
(43) Pub. Date: Nov. 12, 2009

(54) AN IMPROVED APPARATUS FOR ATTRACTING, TRAPPING, DAMAGING INSTANTLY AND KILLING OF INSECTS

(76) Inventor: Ignatius Orwin Noronha, Mangalore (IN)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/374,435

(22) PCT Filed: Jul. 11, 2007
(86) PCT No.: PCT/IN07/00285

§ 371 Date: Jan. 20, 2009

(30) Foreign Application Priority Data
Jul. 21, 2006 (IN) 1275CHE2006
Dec. 29, 2006 (IN) 2452CHE2006

(51) Int. Cl. A01M 1/08

(52) U.S. Cl. 43/113; 43/118

(57) ABSTRACT

Multipurpose apparatus capable of attracting, trapping, damaging instantly and subsequent killing of insects including mosquitoes which comprises of a supporting cylindrical body (3) with open ends, the body provided with a removable cover (1) on open top end (2) fixed with supporting legs (12) leaving sufficient gap between cover and body, having a UV lamp (6) with a protective safety cover (4) fitted internally below top open end and a removable insect collecting part (8) installed at other end, UV lamp is closely enclosed with a heat conducting wire mesh (5) which further extends horizontally to entire diameter of axial fan's opening, an axial fan (7) is fitted above the protective wire mesh guard (17) and beneath UV lamp and heat conducting wire mesh (5).

### FIELD OF INVENTION

The present invention relates to an improved apparatus for attracting, trapping, damaging instantly and subsequent killing of insects. The invention particularly relates to an apparatus for attracting, trapping, damaging instantly and subsequent killing of insects, especially Mosquitoes. The present invention more particularly relates to a multipurpose apparatus for attracting, trapping, damaging instantly and subsequent killing of mosquitoes and other insects, particularly the mosquitoes. The apparatus of the present invention is, therefore, useful for attracting, trapping, damaging instantly and subsequent killing of blood sucking mosquitoes, black flees midges and unwanted harmful insects usually found inside the rooms where people live. The apparatus of the present invention will also act as a protective cover to save the eye sight of human beings and pet animals from the dangers of using Ultra Violet light source inside room. In the apparatus of the present invention, the heat required to damage instantly and subsequently to kill the insects particularly mosquitoes is generated automatically from the existing Ultra Violet light tube itself free of cost thereby eliminating the need of additional expensive electric grid and transformer to kill them. The apparatus of the present invention can also be used for external use by fixing a removable wire mesh of approx. above 5 mm square size in between the top cover and the top open end of the apparatus to protect and save useful and harmless insects found in the nature from getting them attracted, trapped and killed. The apparatus of the present invention helps to minimize formation of dust particles in the rooms where it is installed for operation as the dust particles found in the room, get sucked towards the impeller of the axial fan and get themselves collected on the borders of impeller which could be cleaned periodically. The apparatus of the present invention also serves as a bed lamp besides its actual performance if used in the bedroom thereby saving cost of bed lamp fittings along with cost of bed lamp bulb and also saving additional electricity and electricity cost on use of separate bed lamp in the bed rooms. The apparatus of the present invention is safe with protective wire mesh guard to prevent danger of touching the impeller of axial fan while it is in operation. The apparatus of the present invention is efficient to perform better in attracting maximum insects like mosquitoes due to the top cover provided above the supporting body by providing better glowing effect from the UV lamp source. The apparatus of the present invention is accurate in performance for attracting insects like mosquitoes due to the black colour of the external side of the supporting body and of the cover and due to the white colour of the internal side of the supporting body and the cover of the apparatus for providing better glowing effect from the UV lamp source. The apparatus of the present invention is protective due to the top cover having bigger dimension than the supporting body to protect the electrical components from rain water while using the same for outdoor purposes. The apparatus of the present invention is capable to operate with low power consumption between 8 Watt to 18 Watt output enabling it to operate even with battery backup for longer duration during power cuts or power failures.

### PRIOR ART

Every human being born on the earth shall have the experience of free bite from the Mosquitoes. Mosquitoes are the main cause for mosquito borne diseases like Malaria, Dengue, Yellow Fever, Chikoon Gunya, Elephantiasis, etc. which lead many people to die and rest of them to suffer during the treatment stage. Mosquitoes detect human beings and animals by their smell, black colour of hair, heat of the body and the carbon dioxide exhaled while breathing.

### Health Hazards Due to Use of Mosquito Repellents

Researchers are now providing data on the harmful effects of repellents used against mosquitoes. The main site of action of the pyrethroids is the sodium channel, which is kept open for long periods of time, causing prolonged sodium Diel et al. reported the immunotoxic properties of s-bioallethrin caused by inhibiting lymphocyte proliferation in a dose-dependent manner. D-transallethrin, through hormonal pathways, may contribute to reproductive dysfunction, development impairment and cancer.

A group of leading medical practitioners recently issued a warning that Allethrin (a synthetic pyrethroid) based mosquito coils and mats can cause health hazards and their use should be avoided or discouraged. Research done in western countries has also established that prolonged use of mats is harmful for humans. It can lead to corneal damage, shortness of breath, asthma and even damage liver in the long run.

Certain chemicals used in the mats and coils can adversely affect male and female fertility. The blotting paper used in the preparation of the mats contains dioxin, a proven carcinogen. Traces of dioxin are released from the mat during the heating process. When allethrin was produced in America about 40 years ago its use was intended for outdoor purposes only. But the Indian scene is very different. Here many persons stay in a single room. Use of allethrin based coils and mats in such cramped indoor settings makes it even more dangerous.

A well-known malaria specialist has said that safety issues related to prolonged usage of Allethrin, which is a potent insecticide, are yet to be studied completely for its side effects on humans in the Indian situation. Studies in China too have proved that long-term exposure can lead to adverse effects, especially in lightweight individuals particularly children. Infants exposed to mosquito repellent mats have been known to suffer from convulsions.

The proper and effective use of mosquito coils and mats involves uniform heating at a temperature of about 800 C. The vapours from heated coils and mats keep the mosquitoes and other insects out. The mats contain a nerve poison, which affects the nervous system of insects and their host finding ability is impaired. This can cause allergy in some people.

Some time people use liquid drops of these repellents to reuse the mats, which is a wrong practice. The mats are made of thick blotting paper that loses its ability to uniformly absorb and release allethrin after one use. A mosquito mat contains only 1 percent to 1.2 percent of allethrin by weight, which on slow evaporation gets dispersed in the air. The mat manufacturers recommend closure of all windows and doors for about an hour, after putting the mat burner on for best results. But they don't recommend opening of the windows and doors after that duration.

All external use mosquito killing machines using LPG burner and Co2 cylinder have failed due to their high pricing and due to thermostat problems in their performance of such LPG Burner operated machines resulting in melting of plastic based components. As per the News from U.S. Consumer Product Safety Commission, in cooperation with CPSC The Coleman Company Inc. USA has voluntarily recalled about 136000 units of Mosquito Deleto Traps and Back Home System Trap which pose a fire hazard to consumers. See U.S. Pat. Nos. 6,594,946, 6,655,078, 6,892,492, 6,779,296, 6,718,685, 6,655,080, 6,145,243. Especially Co2 cylinder based machines have failed due to the dangers of explosion if exposed to sunlight and due to practical problem in using them economically its highly compressed co2 gas. Such machines are heavy for movement from one place to other. See U.S. Pat. Nos. 6,199,316, 5,813,166.

The use of a special attraction light and an electric screen grid in combination to kill insects has been developed. Such apparatus thus constructed are dangerous for human use as the radiation from the directly visible light emitted shall lead people to lose their eye sight on its use. Additionally electric grid with transformer is expensive. It consumes additional electricity at additional expense to electrocute the insects besides it is dangerous if touched by human beings or animals. The electric grid make unpleasant sounds and spread an odor smell around while electrocuting the insects besides the parts of insects fly around due to the bursting effect which is not hygienic. Most of such traps have got minimum two UV light tubes flat type or one circular type UV light tube and the light emitted from such traps is more bright than what is required which prevent them to use during night in the bedroom as it disturbs the sleep of people while it is in use and also it will lead people and pet animals to lose their eye sight due to its Ultra Violet features. See U.S. Pat. Nos. 7,036,269, 6,560,918, 6,134,826, 5,255,468, 5,020,270. 4,908,978, 4,523,404, 2,806,321, 3,041,773 and 3,152,420, U.S. patent application Ser. No. 10/484,090 dated 16 Jan. 2004 and International Patent Application No. PCT/KR02/00170 dated Jun. 2, 2002.

There are many disadvantages of using electrocution systems. Using high voltage electrocuting systems in premises where food is handled is definitely dangerous and certainly not desirable. The flying insect parts can contaminate the food products with dangerous consequences. Besides this the disintegrated insect parts due to electrocution could be a major health hazard; the insect scales, hairs, and body parts are known to be potential allergens and can lead to variety of respiratory conditions. Many a times testing to find out whether a grid in the electrocuting system is operational can be cumbersome and may even be fraught with dangers.

Some trapping apparatus use special attractant like lactic acid and octenol which is a chemical based product as it is not eco-friendly and not recommended to use indoors. Such chemicals need special care to handle them and specially to dispose them after their use as they lead contamination of portable water. Reference in this context may be made to the U.S. Pat. Nos. 6,199,316, 6,892,492.

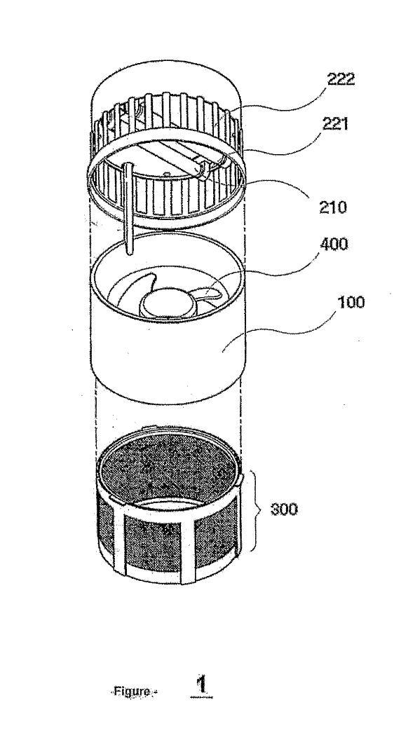

In the U.S. patent application Ser. No. 10/484,090 dated 16 Jan. 2004 and the corresponding International Patent Application No. PCT/KR02/00170 dated Jun. 2, 2002 mosquito repelling apparatus has been disclosed, shown in FIG. 1 of the drawing accompanying this specification, which includes a collecting container (100) having an inlet, an outlet and a vacant space therein, an Ultra Violet lamp (210) installed at the inlet for repelling mosquitoes, a collecting chamber (300) installed at the outlet of the chamber, a fan (400) installed within the collecting chamber such that the mosquitoes are killed by the ultraviolet rays and is sucked into the collecting net during operation and an optical catalyst coated layer is provided at least one of the surfaces of the collecting chamber.

The lamp includes a body having a lamp seat (221) for maintaining a spaced distance between the ultra violet ray lamp (210) and the inlet of the collecting container (100) and grids (222) provided between the lamp body seat (221) and the container (100)

It is claimed in the said patent application that by the use of the above apparatus the mosquitoes will be killed, only with the operation of the fan and by the Ultra Violet lamp, but in practical all the mosquitoes will not be killed with the operation of the fan only, since the power full outward blowing force of the fan will make many of the mosquitoes to escape directly into the collecting net without killing them between the opening space of the fan's frame body and the impeller. Also, the UV lamp in the apparatus cannot also kill the mosquitoes instantly as it is installed at a much higher elevation at top side of the grids (222) and the mosquitoes when sucked inside, would be vacuumed inside downwards from the lower level of the grids, without getting them to touch or getting them in direct contact with the UV Lamp.

It is also stated in their claim, in Detailed Description of the Invention and in Best Mode for carrying out the Invention of the above mentioned patent application that a mosquitoes-enticing lamp (210) with ultraviolet ray installed at the inlet of the collecting container (100) for attracting mosquitoes. Preferably the ultraviolet ray mosquito-enticing lamp comprises an ultraviolet ray lamp (210) having a wavelength ranged from 300 nm to 400 nm. The ultraviolet ray enticing lamp is fixed within the apparatus exposing the same directly for human visibility which is dangerous for human eye sight and also to the skin, besides ultra violet rays of said apparatus are of UV-A type and UV-B type rays having wavelength range between 300 nm to 400 nm emitted from the ultraviolet ray enticing lamp (as per standards UV-B is having wavelength of 290 nm to 320 nm and UV-A is having wavelength of 320 nm to 400 nm) without any protective safety cover is harmful for their use causing skin irritation (erythema) and eye irritation (conjunctivitis).

Furthermore, it is also claimed that in addition it is preferable to provide the collecting container (100) with electro-shock device for destroying the mosquitoes attracted in the collecting container. The electro-shock device may be located on an upper or lower portion of the fan, and includes iron wires (not shown) which are provided within the collecting container in such a manner that the wires are spaced apart from each other at a desired interval. The wires are connected to an external power source so that a voltage is applied to the wires. The iron wires within the Electro-shock device when voltage is applied with an external power source mentioned as per above mentioned patent application acts as electrocuting grid and electrocution, the disadvantages of which have already been explained above.

It is further claimed in the above patent application that a photo catalyst-coated layer coated on at least one surface of the collecting container. It is an expensive process to provide photo catalyst-coated layer using the material produced from Nano Technology. Further it needs to expose the coated surface to high temperature above 800 degree C. for certain time to obtain photo catalyst properties to the coated layer which is not possible to provide such effect on plastic based surface. Furthermore, it is not a compulsory requirement to provide photo catalyst-coated layer within the apparatus as the apparatus is required to perform during the night as the insects particularly mosquitoes are mostly attracted and found within the rooms due to people live in the room emit co2 while breathing.

The power consumption of the apparatus disclosed in the above mentioned US Patent Application and International Patent Application as per their own specifications is 30 W which is on higher side and also adding extra electricity charges to the users. It needs bigger battery backup at additional expensive cost to operate the apparatus for longer duration during power cuts and power failures.

The trapped live mosquitoes and insects from apparatus having only ultra violet attraction light without any killing provision shall fly back and escape when ever there is power failure as they are not killed for long time within the collection net.

The electrical components like UV light tube, Electronic Circuit, electrical parts of electrocuting grid and electrical parts of fan like motor coil of similar traps often fail during their operation when ever there is slight power fluctuation and cause unnecessary replacement cost of such components frequently. Such traps are discarded by the users from use permanently after repetitions of few replacements at their cost.

As mentioned earlier efforts have been made to use strong chemicals both the volatile and non-volatile like pyrethroids and organophosphates to immobilize and inactivate the insects in the traps. But the results where not satisfactory and consistent. Moreover there could be danger of chemical contamination and added pollution. Reference may be made to U.S. Pat. Nos. 6,920,716, 6,823,622, 6,425,202, 5,983,557, 5,749,168.

Some insect traps include a sticky substance capable of ensnaring the insects entering the trap. A sticky substance applied as a coating on the paper or other sheet material is often used for this purpose. The main disadvantage of these traps is that the adhesive characteristics of the sticky substance usually diminish over the time. There is a need for periodic replacement of these sheets. Such traps may also become unsightly owing to accumulation of dead insects on the glue sheet. Reference may be made to the U.S. Pat. Nos. 7,096,621, 6,886,292, 6,758,009, 6,718,687, 6,574,914, 6,560,919, 6,481,152, 5,915,948, 5,505,017, 5,365,690, 5,231,790, 5,203,816, 4,959,923, 4,876,822, 4,696,126.

Hence there is a need for an improved insect attracting, trapping and killing device which can overcome the above mentioned problems of the hitherto known devices.

### OBJECTIVES OF THE PRESENT INVENTION

Therefore the main objective of the present invention is to provide an improved apparatus for attracting, trapping, damaging instantly and subsequent killing of insects more particularly blood sucking Mosquitoes.

Another objective of the present invention is to provide an improved and safe apparatus for attracting, trapping, damaging instantly and subsequent killing of insects wherein the apparatus will also act as a protective shield to save the eye sight of human beings and pet animals from the dangers of losing their eyesight by using the directly visible Ultra Violet Lamp source.

Still another objective of the present invention is to provide an improved and economical apparatus for attracting, trapping, damaging instantly and subsequent killing of insects wherein the heat required to damage instantly and subsequent to kill the insects particularly mosquitoes is generated automatically free of cost from the existing Ultra Violet Lamp source which is directly not visible thereby eliminating need of additional electric grid and transformer to kill them and saving cost of additional electricity bill.

Yet another objective of the present invention is to provide an improved and user friendly apparatus for attracting, trapping, damaging instantly and subsequent killing of insects wherein the apparatus does not use any sticky substances.

Another objective of the present invention is to provide an improved and eco-friendly apparatus for attracting, trapping, damaging instantly and subsequent killing of insects wherein the apparatus does not use any harmful chemicals.

Still another objective of the present invention is to provide an improved and harmless apparatus for attracting, trapping, damaging instantly and subsequent killing of insects wherein the apparatus does not make any unpleasant bursting sounds and spreading around insect's parts of electrocuting system.

Still another objective of the present invention is to provide an improved and multi-purpose apparatus for attracting, trapping, damaging instantly and subsequent killing of insects wherein the apparatus also provide light required as equivalent to bed lamp if is to be used in the bedrooms.

Still another objective of the present invention is to provide an improved and hygienic apparatus for attracting, trapping, damaging instantly and subsequent killing of insects wherein it also helps to keep the room dust free by vacuuming and collecting the dust particles on the borders of impeller of the axial fan placed within the apparatus which could be easily cleaned periodically.

Another objective of the present invention is to provide an improved and environmental friendly apparatus for attracting, trapping, damaging instantly and subsequent killing of insects wherein having more surface area at the instant damaging zone through removable protective safety cover and the heat conducting wire mesh by getting them heated freely by the Ultra Violet Lamp source without any additional electricity cost.

Another most useful objective of the present invention is to provide an improved and multi-purpose apparatus for attracting, trapping, damaging instantly and subsequent killing of insects wherein it helps to protect the users from getting themselves any mosquito borne diseases.

Still another objective of the present invention is to provide an improved and economical apparatus for attracting, trapping, damaging instantly and subsequent killing of insects wherein the apparatus is capable to operate with low power consumption of 8 Watt on DC power or of 18 Watt on AC power output enabling it to operate even with small battery backup for longer duration during power cuts or power failures.

Still another objective of the present invention is to provide an improved and economical apparatus for attracting, trapping, damaging instantly and subsequent killing of insects wherein the apparatus is esthetic, simple, light weight, durable and compact.

Still another objective of the present invention is to provide an improved and efficient and powerful apparatus for attracting, trapping, damaging instantly and subsequent killing of insects wherein to perform better in attracting maximum insects like mosquitoes due to the top cover provided above the supporting body for providing better glowing effect from the UV lamp source and for creating powerful suction effect near the top open end.

Still another objective of the present invention is to provide an improved and accurate apparatus for attracting, trapping, damaging instantly and subsequent killing of insects wherein for better performance in attracting insects like mosquitoes due to the black colour of the external side of the apparatus which is one of the attractants to the mosquitoes and due to the white colour of the internal side of the apparatus for providing limited glowing effect as much as required from the UV lamp source visible to the insects like mosquitoes from any angle which is also another attractant to the mosquitoes.

Still another objective of the present invention is to provide an improved and protective apparatus for attracting, trapping, damaging instantly and subsequent killing of insects wherein to protect the electrical components from rain water while using the same for outdoor purposes with its top cover having bigger dimension than the supporting body.

Still another objective of the present invention is to provide an improved and safe apparatus for attracting, trapping, damaging instantly and subsequent killing of insects wherein the apparatus is safe with protective wire mesh guard to prevent danger of anybody touching the impeller of axial fan while it is in operation.

Still another objective of the present invention is to provide an improved and suitable apparatus for attracting, trapping, damaging instantly and subsequent killing of insects wherein the apparatus can also be used for external use by fixing a removable wire mesh of approx. above 5 mm square in between the top cover and the top open end of the apparatus to protect and save useful and harmless insects found in the nature from getting them attracted, trapped and killed.

Another important objective of the present invention is to provide an improved and essential apparatus for attracting, trapping, damaging instantly and subsequent killing of insects wherein to eliminate mosquito population in defined area as it attracts, traps and kills only the female blood sucking mosquitoes thereby controlling the multiplication of mosquito population in that area.

The above said objectives have been achieved by the apparatus of the present invention which are described in detail below with reference to the figures shown in the accompanying specification in the drawings. In the figures:

FIG. 2: represents the cross sectional view of the apparatus showing the internal parts.

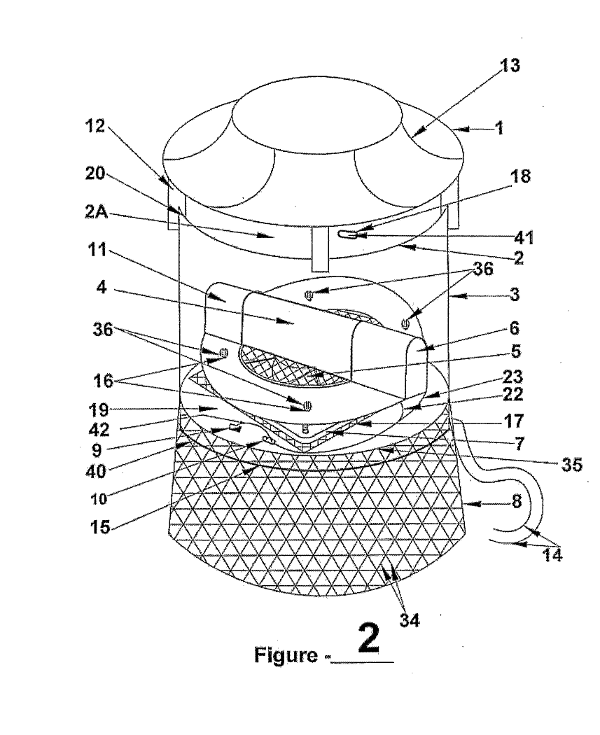

FIG. 3: represents the front view of the apparatus showing the external parts.

FIG. 4: represents the rear or back view of the apparatus showing the external parts.

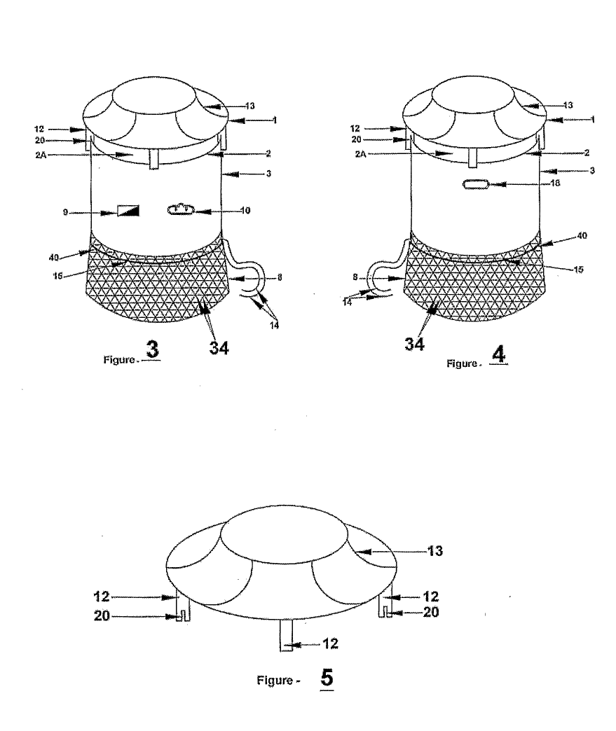

FIG. 5: represents the top and front view of Top Cover (1) of the apparatus having mountable supporting legs (12).

FIGS. 6(a) & 6(b): represents the internal cross-sectional view of both sides of the cylindrical supporting body (3) of the apparatus showing the base plate (19), switch (9), connection pin (10) and handle inlet (18) located on the cylindrical supporting body (3).

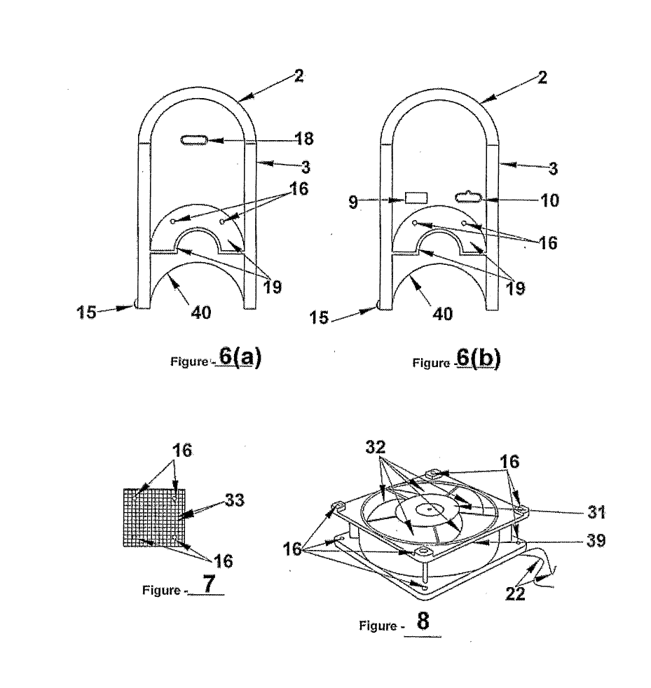

FIG. 7: represents the protective wire mesh guard (17) to be fixed above the base plate (19) and below the axial fan (7) within the supporting body (3).

FIG. 8: represents the side and top view of the axial fan (7) for mounting the same above the Protective wire mesh Guard (17) and below the Ultra Violet Lamp (6) within the supporting body (3).

FIG. 9: represents the top and side view of the Ultra Violet Lamp (6) having all the parts (i.e. power connection wire (23), UV tube (24), Tube holders (28), casing of UV lamp (29) and electronic ballast (30)) to be fixed above the Axial Fan (7) within the supporting body (3).

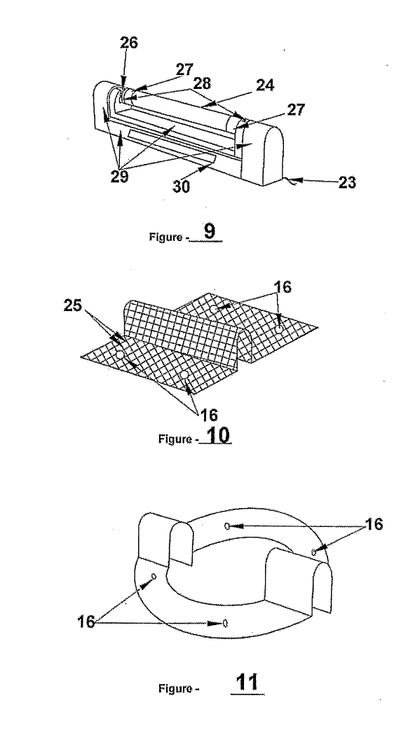

FIG. 10: represents the side and top view of the Heat Conducting Wire mesh (5) for mounting the same below the Protective Safety Cover (4) and above the Ultra Violet Lamp (6) within the supporting body (3).

FIG. 11: represents the side and top view of the guide plate (11) having holes (16) required to fix and hold the Protective wire mesh Guard (17), Axial Fan (7), Ultra Violet Lamp (6) and Heat Conducting wire mesh (5), one above the other to the base plate (19) with the bolts (36) and nuts within the supporting body (3).

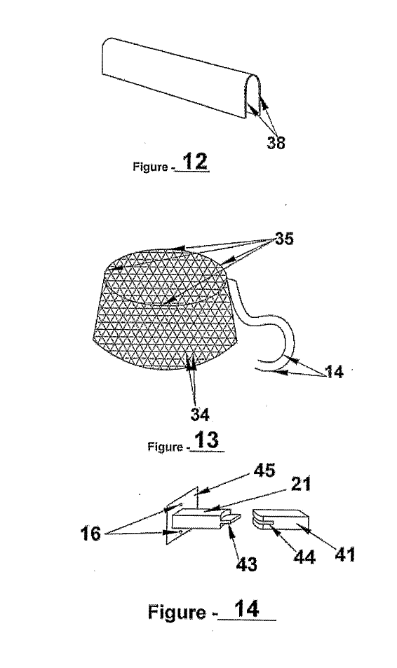

FIG. 12: represents the side and top view of the Protective Safety Cover (4) made in a shape (38) to cover entire surface above the Ultra Violet Lamp (6) within the supporting body (3).

FIG. 13: represents the front and top view of the collecting sac (8) having its open inlet (35) to be tied with a provision (14) at the bottom edge (15) of the supporting body (3).

FIG. 14: represents the side view of the handle (21) with complete set for mounting the same on the wall for installing the supporting body (3).

### SUMMARY OF THE PRESENT INVENTION

Accordingly the present invention provides an improved apparatus for attracting, trapping, damaging instantly and subsequent killing of insects particularly Mosquitoes which comprises a cylindrical supporting body (3) having an open top end (2), a base plate (19) with holes (16) located internally within the supporting body (3) and an open bottom end (40), the open top end (2) being provided with a top cover (1) which is removably fixed to the supporting body (3), the top cover (1) being also provided with supporting legs (12), the legs being provided with slots (20), leaving a gap (2A) between the top cover (1) and the top open end (2) of the supporting body (3) to enable the entry of the insects, particularly mosquitoes, an Ultra Violet lamp (6) provided inside the supporting body (3) located internally at a level below the top open end (2), the Ultra Violet lamp (6) being provided with a removable Protective Safety Cover (4), the Ultra Violet Lamp (6) capable of being connected to a switch (9) with a power connection pin (10) through a electrical wire connection (42), the heat conducting wire mesh (5) having an opening gap between the mesh, being fixed in between the Ultra Violet Lamp (6) and the removable Protective Safety Cover (4) touching directly the top and side surface of the Ultra Violet Lamp Tube (24), the heat conducting wire mesh (5) further extending horizontally to cover the entire diameter of the opening of the inlet area of the axial fan (7), the axial fan (7) being fixed above the protective wire mesh guard (17) and below both the Ultra Violet Lamp (6) and the heat conducting wire mesh (5), the axial fan (7) capable of being connected to the above said switch (9) with a power connection pin (10) through a electrical wire connection (42), a protective wire mesh guard (17) having an opening gap (33) between the mesh which is approximately same or 1 mm less than the opening gap (25) of heat conducting wire mesh (5) being fixed below the axial fan (7) and above the base plate (19), a collecting sac (8) having openings (34) which is less than 1 mm size between the fabric mesh, and its top opening (35) being removably fixed externally with a provision (14) around the bottom edge (15) of the bottom open end (40) of the supporting body (3) for collecting the insects, a guide plate (11) having holes (16) for fixing a protective wire mesh guard (17), an axial fan (7), an ultra violet lamp (6) and a heat conducting wire mesh (5) one above the other to the base plate (19) with the bolts (36) and nuts within the supporting body (3), a handle inlet (18) being provided on one side of the supporting body (3), a handle (21) provided with holes (16) on its wall mounting plate (45) having a projection (43) to insert the same into the handle inlet (18) provided on the supporting body (3) which shall be locked and fixed by the end cap (41) through its slot (44) to mount the apparatus to the wall.

In a preferred embodiment of the invention the supporting body (3) may be preferably cylindrical in shape. The supporting body (3) and the top cover (1) may be made up of opaque or translucent material. Gap (2A) between the top cover (1) and the top open end (2) of the supporting body (3) may be between the ranges of 1 to 4 inches.

The top cover (1) may have a downward slope (13) extended between 1 to 4 inches outside the diameter of the supporting body (3).

The cylindrical supporting body (3) and the top cover (1) is made up in black colour externally and white colour internally of material preferably of Acrylonitrile Butadiene Styrene (ABS) plastic or acrylic or Polypropylene (PP) or Poly Ethylene Terephthalate (PET) or Poly Ethylene Naphthalate (PEN) or equivalent.

The heat conducting wire mesh (5) is made out of Stainless Steel, or copper, or galvanized steel or tungsten wire or equivalent and has an opening gap (25) of approximately between 3-8 mm.

The protective wire mesh guard (17) is made out of Stainless Steel, or copper, or galvanized steel or tungsten wire or ABS plastic or equivalent. The protective wire mesh guard (17) has an opening gap (33) of approximately same or 1 mm less than the opening gap (25) of the heat conducting wire mesh (5)

The collecting part (8) may be a sac like structure in black colour preferably made up of fabric with a provision (14) to tie it around the bottom edge (15) at the bottom open end (40) of the cylindrical support body (3) to collect and retain the dead insects for their disposal. The opening gap (34) of the sac like structure of collecting part (8) has less than 1 mm size.

The Ultra Violet Lamp (6) source may preferably be of 4 Watt to 6 Watt DC or AC output. The Ultra Violet Light tube (24) may preferably be in flat form longer than casing frame (39) of the axial fan (7) or may be in the form of Circular or round shape to fit within the space less than the opening space of axial fan (7).

The Axial Fan (7) may preferably be of 4 Watt DC or 12 Watt AC output. The axial fan & the UV lamp are connected by electrical connection wire (22) and (23).

The removable protective safety cover (4) may be made in a shape (38) for placing the same above both the Ultra Violet Light Tube (24) and the heat conducting wire mesh (5) is black in colour made out of translucent material preferably Polycarbonate or Acrylonitrile Butadiene Styrene (ABS) plastic or acrylic or Polypropylene (PP) or Poly Ethylene Terephthalate (PET) or Poly Ethylene Naphthalate (PEN) or equivalent.

The impeller (32) and the casing frame (39) of axial fan (7) is preferably white in colour.

The guide plate (11) having holes (16) is in white colour made of material preferably of Acrylonitrile Butadiene Styrene (ABS) plastic or acrylic or Polypropylene (PP) or Poly Ethylene Terephthalate (PET) or Poly Ethylene Naphthalate (PEN) or equivalent.

The apparatus may be provided with a handle (21) with complete set for mounting the apparatus on the wall. The handle (21), wall mounting plate (45) and end cap (41) are preferably in black colour made up of Acrylonitrile Butadiene Styrene (ABS) plastic or acrylic or Polypropylene (PP) or Poly Ethylene Terephthalate (PET) or Poly Ethylene Naphthalate (PEN) or metal or equivalent.

An additional wire mesh (not shown in figure) made out of fabric or metal or equivalent having mesh size above 5 mm square size may be remove ably fixed in between the top cover (1) and the top open end (2) of the supporting body (3) covering completely the open gap (2A) of entry to protect and save useful and harmless insects found in the nature from getting them attracted, trapped and killed when the apparatus is used externally for outdoor purposes.

### WORKING OF THE APPARATUS OF THE PRESENT INVENTION

The controlled glowing effect emitted by the Ultra Violet Tube (24) of the Ultra Violet Lamp (6) as the Ultra Violet light reflects on the white colour of the internal side of the cylindrical supporting body (3) and on white colour of the internal side of the top cover (1) inside the apparatus when the apparatus is switched on, along with its generated heat and the black colour of external sides of the apparatus attracts the insects like mosquitoes towards the top open end (2) located between the top cover (1) and the supporting body (3) and get them sucked automatically inside the apparatus because of the powerful suction force created by the axial fan (7) due to the top cover (1) above the open top end (2) through the gap (2A) between the top open end (2) of the cylindrical supporting body (3) and the top cover (1). The insects like the mosquitoes will first hit the automatically heated U shaped (38) removable protective safety cover (4) having large surface area at the instant damaging zone which is hot because of its constant contact with the free heat generating Ultra Violet Tube (24) of the Ultra Violet Lamp (6), then they slowly get in contact with the automatically heated heat conducting wire mesh (5) covering above the entire inlet area of the axial fan (7) which is also hot because of its constant contact with the Ultra Violet Tube (24) of the Ultra Violet Lamp (6). Further the insects particularly mosquitoes as they are pulled inside the opening of the axial fan (7) with its powerful air outflow they will be hit themselves powerfully against the wires of protective wire mesh guard (17) which has got opening gap (33) same or 1 mm smaller than the opening gap (25) of the heat conducting wire mesh (5) located just below the axial fan (7) and get themselves pushed further into the collecting sac (8) due to the powerful air out flow of the axial fan (7) and get themselves instantly damaged and subsequently get themselves killed. The pore size (25 & 33) of both the heat conducting wire mesh (5) and the protective wire mesh guard (17) facilitates the passing of the insects into the collecting sac (8) because of the powerful outflow of air from the axial fan (7) only after hitting them against the wires of both the wire mesh (5 & 17). The guide plate (11) having holes (16) shall hold firmly the Protective wire mesh Guard (17), Axial Fan (7), Ultra Violet Lamp (6) and Heat Conducting wire mesh (5), one above the other to the base plate (19) with the bolts (36) and nuts within the supporting body (3). The collecting sac (8) can be removed through its provision (14) and cleaned to dispose the dead mosquitoes whenever required. The improved apparatus can be mounted to the wall in fixed position at suitable height and location in the room with its handle (21) and handle inlet (18). The improved apparatus capable to operate with low power consumption of 8 Watt on DC power or of 18 Watt on AC power output enabling it to operate even with battery backup for longer duration during power cuts or power failures. The damaged insects like mosquitoes trapped in the collection sac (8) before they are subsequently killed cannot flyback and escape during power cuts or power failures as they are blocked by the protective wire mesh guard (17) and the heat conducting wire mesh (5) within the apparatus.

In this context, on making a close comparison of the apparatus disclosed in the U.S. patent application Ser. No. 10/484,090, the closest prior art, with the apparatus of the present invention, it can be clearly seen that the constructional features of the two apparatus are quite different. The only common features being the employment UV light & a fan. Hence the apparatus of the present invention is novel which can be confirmed by the following facts:

In the improved apparatus of the present invention, top most priority is given with respect to the health aspect of its users specially people and pet animals to protect their eye sight and skin related problems. In the apparatus of US Patent Application the UV lamp is installed on the top of the body which is visible to the eyes of its users from any angle. On the other hand, in the improved apparatus of the present invention, the UV lamp is installed internally inside the supporting body so that the UV lamp is not visible to its users from any angle. In the apparatus of US Patent application the body having a seat for maintaining a spaced distance between the UV lamp and the inlet of collecting container. The body is having grids through the opening of the said grid which is between the lamp body seat and the collecting container, the UV lamp is directly exposed to human sight from any angle whereas in the improved apparatus the UV lamp is installed internally inside the supporting body so that the UV lamp is not visible to human eyes from any angle. There is no Protective Safety cover above the UV lamp in the apparatus of US patent application whereas a protective safety cover is provided above the UV Lamp in the improved apparatus to reduce the UV light and also to protect from dangers of using UV lamp. There is no Heat Conducting Wire Mesh above the UV lamp in the apparatus of US patent application whereas Heat Conducting Wire Mesh above the UV Lamp is provided in improved apparatus to damage the mosquitoes as they are sucked inside the apparatus. There is no protective wire mesh guard below the axial fan in the apparatus of US patent application whereas a protective wire mesh guard below the axial fan is provided in improved apparatus to protect the user from dangers of direct contact with the impeller. There is additional photocatalyst coating given to the internal surface of the apparatus of US patent application where as no photocatalyst coating is provided in improved apparatus as it is capable of performing without photocatalyst coating. There is electro-shock devise connected through external power source within the apparatus of US patent application whereas no electro-shock device having external power source is installed in improved apparatus as the killing performance is done without bursting and spreading around of insect parts. The protective safety cover provided in the apparatus of the present invention, entirely covers all the exposed surface of the ultra violet lamp. Seeing ultra violet light directly for more than 5 minutes is equivalent of seeing sun light directly with naked eyes which would lead to lose the eye sight. Due to the use of protective safety cover within the apparatus the brightness of UV light within the room is also reduced equivalent to a bed lamp light besides the protection to the eyes. Consequently the apparatus can also be used as a bed room lamp besides its attracting, trapping and killing of the insects

Mostly the blood sucking mosquitoes hide themselves in the rooms behind the curtains or hanged clothes, or above lofts, etc. and shall keep on biting people until they complete their blood meal during the night in the bed rooms where people sleep. The improved apparatus assist to attract, trap and kill the mosquitoes during the night without disturbing the sleep of people whereas the apparatus of US patent application cannot be used in the bed rooms as people cannot sleep due to its eyes irritating UV light.

The supporting body and top cover of improved apparatus is made in opaque or translucent material with black colour on external side and white colour on internal side allowing the apparatus to emit controlled glowing light from the ultra violet lamp through the opening gap for insects to get attracted from any angle.

The cost of replacement of parts in improved apparatus is low as it needs only one ultra violet tube to replace whereas the cost of replacement of parts in apparatus of US patent application is high as it needs two ultra violet tube to replace. The damaging and killing function of improved apparatus is quiet, silent and clean due to the heat generated freely from the ultra violet lamp.

The above described differences in the constructional features of the apparatus of the present invention provides the following advantages as compared to the apparatus disclosed in the US patent application:

### ADVANTAGES OF THE PRESENT INVENTION

1. The improved apparatus helps saving the eyes of human beings and of pet animals from the dangers in using such Ultra Violet light source.

2. The improved apparatus eliminates the need of additional electric grid and transformer to kill the insects thereby saving the cost on electricity consumption on such electrical components.

3. The improved apparatus does not use any sticky substances and does not make unpleasant bursting sounds and spreading around insect's parts of other electrocuting system. Hence the apparatus is environmentally friendly.

4. The improved apparatus is compact, simple, light weight, durable and economical.

5. The improved apparatus is efficient and powerful which perform better in attracting maximum insects like mosquitoes due to the top cover provided above the supporting body for providing better glowing effect from the UV lamp source and for creating powerful suction effect near the top open end.

6. The improved apparatus is accurate in performance for attracting insects like mosquitoes due to the black colour of the external side of the apparatus which is one of the attractants to the mosquitoes and due to the white colour of the internal side of the apparatus for providing limited glowing effect as much as required from the UV lamp source visible to the insects like mosquitoes from any angle which is also another attractant to the mosquitoes.

7. The improved apparatus is protective to protect the electrical components from rain water while using the same for outdoor purposes with its top cover having bigger dimension than the supporting body.

8 The improved apparatus is safe with protective wire mesh guard to prevent danger of any one touching the impeller of axial fan while in operation.

9. The improved apparatus can be used as a bed lamp in the bed room besides its attracting, trapping and killing performance.

10. The improved apparatus is eco-friendly as no chemicals are used.

11. The improved apparatus is hygienic as it is very easy to dispose the dead insects as they are collected within the collection sac and they do not fall out or its parts do not spread around.

12. The improved apparatus helps to keep the rooms dust free as the dust is vacuumed along with the air and collects the dust around the impeller of the axial fan which could be cleaned periodically.

13. The improved apparatus capable to operate with low power consumption between 8 Watt to 18 Watt output enabling it to operate even with battery backup for longer duration during power cuts or power failures.

14. The improved apparatus helps the users to protect themselves from mosquito bites and mosquito borne diseases like malaria, dengue, yellow fever, chickoon gunya, elephantiasis, etc.

15. The improved apparatus can also be used for external use by fixing a removable wire mesh of approx. above 5 mm square size in between the top cover and the top open end of the apparatus to protect and save useful and harmless insects found in the nature from getting them attracted, trapped and killed.

16 The improved apparatus helps its users to eliminate mosquito population in defined area as it attracts, traps and kills only the female blood sucking mosquitoes thereby controlling the multiplication of mosquito population in said area.

1. An improved apparatus for attracting, trapping, damaging instantly and subsequent killing of insects, said apparatus comprising a cylindrical supporting body having an open top end, a base plate located internally within the supporting body and an open bottom end, the open top end being provided with a top cover which is removably fixed to the supporting body, the top cover also being provided with supporting legs to form a gap between the top cover and the open top end of the supporting body to enable the entry of the insects, an ultra violet lamp provided inside the supporting body located internally at a level below the top open end, the ultra violet lamp being provided with a removable protective safety cover, the ultra violet lamp being connected to a switch with a power connection pin through an electrical wire connection, a heat conducting wire mesh having an opening gap and being fixed in between the ultra violet lamp and the removable protective safety cover and touching directly a tube of the ultra violet lamp, the heat conducting wire mesh further extending horizontally to cover an entire opening of an inlet area of an axial fan, the axial fan being fixed above a protective wire mesh guard and below both the ultra violet lamp and the heat conducting wire mesh, the axial fan (7) being connected to said switch, the protective wire mesh guard being fixed below the axial fan and above the base plate, a collecting part removably fixed to the open bottom end of the supporting body for collecting the insects, and a guide plate fixing the protective wire mesh guard, the axial fan, the ultra violet lamp and the heat conducting wire mesh one above the other to the base plate within the supporting body.

2. An improved apparatus as claimed in claim 1, wherein the gap between the top cover and top open end of the supporting body is in the range of 1 to 4 inches.

3. An improved apparatus as claimed in claim 1, wherein the top cover has a downward slope extended in the range of 1 to 4 inches outside a diameter of the cylindrical supporting body.

4. An improved apparatus as claimed in claim 1, wherein the heat conducting wire mesh has opening gaps in the range of 3-8 mm.

5. An improved apparatus as claimed in claim 4, wherein the protective wire mesh guard has opening gaps in the range of the same as the opening gaps of the heat conducting wire mesh to 1 mm less than the opening gaps of the heat conducting wire mesh.

6. An improved apparatus as claimed in claim 1, wherein the collecting part is a sac like structure preferably made up of fabric provided with a provision to fix it around, a bottom edge at the bottom open end of the supporting body to collect and retain the dead insects for their disposal.

7. An improved apparatus as claimed in claim 6, wherein the opening gaps of the sac like structure of the collecting part have a size of less than 1 mm.

8. An improved apparatus as claimed in claim 1, wherein the ultra violet lamp operates with power source between 4 Watt to 6 Watt output, and the axial fan operates with power source between 4 Watt to 12 Watt output.

9. An improved apparatus as claimed in claim 1, wherein a handle is provided having holes on its mounting plate and provided with a projection for insertion into a handle inlet provided on the supporting body which shall be locked and fixed by an end cap through a slot of the end cap receiving the projection for mounting the apparatus at required height on a wall.

10. An apparatus for attracting, trapping, damaging instantly and subsequent killing of insects, said apparatus comprising:
a cylindrical supporting body having an open top end, a base plate located internally within the supporting body, and an open bottom end;
a top cover provided at the open top end which is removably fixed to the supporting body, the top cover being provided with supporting legs to form a gap between the top cover and the open top end of the supporting body to enable the entry of the insects into the supporting body;
an ultra violet lamp located inside the supporting body at a level below the top open end so that the ultra violet lamp is not directly visible from outside the supporting body, the ultra violet lamp connected to a switch with a power connection pin through an electrical wire connection;
an axial fan located within the supporting body below the ultra violet lamp (6), the axial fan connected to said switch; and
a collecting part removably fixed the open bottom end of the supporting body for collecting the insects.

11. An apparatus as claimed in claim 10, further comprising a heat conducting wire mesh having an opening gap and being fixed in between the ultra violet lamp and a removable protective safety cover and touching directly a tube of the ultra violet lamp.

12. An apparatus as claimed in claim 11, wherein the heat conducting wire mesh extending horizontally to cover an entire opening of an inlet area of the axial fan.

13. An apparatus as claimed in claim 11, wherein the heat conducting wire mesh has opening gaps in the range of 3-8 mm.

14. An apparatus as claimed in claim 11, further comprising a protective wire mesh guard being fixed below the axial fan and above the base plate.

15. An apparatus as claimed in claim 14, further comprising a guide plate fixing the protective wire mesh guard, the axial fan, the ultra violet lamp, and the heat conducting wire mesh one above the other to the base plate within the supporting body.

16. An apparatus as claimed in claim 14, wherein the protective wire mesh guard has opening gaps in the range of the same as the opening gaps of the heat conducting wire mesh to 1 mm less than the opening gaps of the heat conducting wire mesh.

17. An apparatus as claimed in claim 10, wherein the gap between the top cover and top open end of the supporting body is in the range of 1 to 4 inches.

18. An apparatus as claimed in claim 10, wherein the top cover has a downward slope extended in the range of 1 to 4 inches outside a diameter of the cylindrical supporting body.

19. An improved apparatus as claimed in claim 10, wherein the collecting part is a sac like structure made up of fabric and fixed at the bottom open end of the supporting body to collect and retain the dead insects for their disposal.

20. An improved apparatus as claimed in claim 19, wherein opening gaps of the sac like structure of the collecting part have a size of less than 1 mm.
